(19) United States
(12) Patent Application Publication
(10) Pub. No.: US 2005/0273998 A1
(43) Pub. Date: Dec. 15, 2005

(54) Electrical machine coil spreading method and apparatus

(76) Inventor: Charles F. Requet III, Madison, IN (US)

Correspondence Address: Alexander M. Gerasimow;Allen-Bradley Company, LLC, 1201 South Second Street, Milwaukee, WI, 53204-2496, US

(21) Appl. No.: 10/857,334

(22) Filed: May 28, 2004

(51) Int. Cl. H02K 15/00; B23P 19/00

(52) U.S. Cl. 29/596; 29/734

(57) ABSTRACT

In accordance with one embodiment, the present technique provides a separation mechanism configured to mechanically drive adjacent end turns radially apart from one another. By way of example, the separation mechanism mechanically actuates one end turn in a radially outward direction, while mechanically actuating a second end turn in a radially inward direction. Advantageously, the mechanical separation facilitates the insertion of phase paper between adjacent end turns.

### BACKGROUND

The present invention relates to electric motors and particularly to the coil windings within a motor stator of an electric motor.

Electric motors of various types are commonly found in industrial, commercial and consumer settings. In industry, such motors are employed to drive various kinds of machinery, such as pumps, conveyors, compressors, fans and so forth, to mention only a few. Conventional alternating current (ac) electric motors may be constructed for single- or multiple-phase power, and are typically designed to operate at predetermined speeds or revolutions per minute (rpm), such as 3600 rpm, 1800 rpm, 1200 rpm, and so on. Such motors generally include a stator comprising a multiplicity of windings surrounding a rotor, which is supported by bearings for rotation in the motor frame. Typically, the rotor comprises a core formed of a series of magnetically conductive laminations arranged to form a lamination stack capped at each end by electrically conductive end rings. Additionally, typical rotors include a series of conductors that are formed of a nonmagnetic, electrically conductive material and that extend through the rotor core. These conductors are electrically coupled to one another via the end rings, thereby forming one or more closed electrical pathways.

In the case of ac motors, applying ac power to the stator windings induces a current in the rotor, specifically in the conductors. That is, at a given point in time, alternating levels and polarities of current are routed through the various coil winding. This varied routing of current causes electromagnetic relationships between the rotor and the stator that induce rotation of the rotor. The speed of this rotation is typically a function of the frequency of ac input power (i.e., frequency) and of the motor design (i.e., the number of poles defined by the stator windings). A rotor shaft extending through the motor housing takes advantage of this produced rotation and translates the rotor's movement into a driving force for a given piece of machinery. That is, rotation of the shaft drives the machine to which it is coupled.

During construction of the motor, the coil winding are often inserted simultaneously into the stator core. That is, the coil windings, which are coupled to various electrical inputs, are simultaneously inserted into their respective stator slots. However, by inserting the coil windings simultaneously, adjacent end turns of the stator windings, which, again, may be coupled to different electrical inputs, are close to one another and, as such, can come into contact. During operation, contact between the end turns of the stator can lead to electrical malfunctions, such as a short circuit, for instance. Accordingly, to prevent short circuits, for example, the end turns are electrically isolated from one another by a layer of dielectric material, which is often referred to in the industry as “phase paper.”

Insertion of phase paper is traditionally a labor-intensive process, because of the proximity between adjacent end turns of the stator. Traditionally, to provide sufficient clearance between adjacent end turns of the stator, a technician traditionally manually pries the adjacent end turns apart. This manual separation can cause inconsistencies between the constructions of the various coil windings and can increase the time of manufacture for the motor. Moreover, to provide sufficient leverage for the technician, the end turns contain more copper material than is electrically necessary. That is to say, the end turns contain more copper than is necessary for operation, leading to increased costs. Furthermore, manual separation of end turns may require more leverage than a technician is able to apply.

There is a need, therefore, for an improved technique for separating coil windings within a motor stator.

### BRIEF DESCRIPTION

In accordance with one embodiment, the present technique provides an apparatus for separating adjacent end turns of a motor stator. The apparatus includes a separation mechanism that is configured to mechanically drive at least one of a pair of adjacent end turns radially apart with respect to one another. Accordingly, the radial separation distance between the two adjacent end turns is increased, thereby facilitating the insertion of phase paper between the adjacent end turns. By way of example, the separation mechanism may include a hydraulic device that actuates an engagement member in the appropriate directions, thereby radially separating the end turns with respect to one another.

In accordance with another embodiment, the present technique provides another apparatus for separating end turns of a motor stator. The exemplary apparatus includes a separation mechanism that actuates an engagement member between first and second positions, such that the engagement member drives an end turn in the desired radial direction. Additionally, the exemplary apparatus includes an indexing mechanism configured to position at least one of the motor stator and the engagement member with respect to one another such that the engagement members aligns with a predefined location on the end turn.

Additionally, the present technique provides an exemplary method for manufacturing a motor stator. The exemplary method includes the act of mechanically driving at least one of a first end turn in a radially inward direction with respect to the stator and a second end turn, which is adjacent to the first end turn, in a radially outward direction with respect to the stator. Accordingly, this mechanical displacement of the adjacent end turn increases the radial separation distance therebetween. In turn, this increase radial separation facilitates another element of the exemplary method: inserting a dielectric material between the first and second end turns such that the first and second end turns are electrically isolated from one another.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an exemplary motor, in accordance with an embodiment of the present invention;

FIG. 2 is a partial cross-sectional view of the exemplary motor of FIG. 1 along line 2-2;

FIG. 3 illustrates a stator and a plurality of end turns in the stator prior to an end turn expansion procedure, in accordance with an embodiment an embodiment of the present invention;

FIG. 4 illustrates a cross-section of the stator and end turns of FIG. 3 along line 4-4;

FIG. 5 a illustrates cross-section of the stator core and end turns of FIG. 3 along line 4-4 subsequent to an end turn expansion procedure, in accordance with an embodiment of the present invention;

FIG. 6 illustrates a stator and a plurality of end turns in the stator subsequent to a end turn expansion procedure, in accordance with an embodiment of the present invention;

FIG. 7 illustrates an exemplary system for separating end turns of a motor stator, in accordance with an embodiment of the present invention;

FIG. 8A illustrates an initial stage of a radially outward separation procedure for an end turn, and FIG. 8B illustrates a terminal stage of the radially outward separation procedure for the end turn, in accordance with an embodiment of the present invention;

FIG. 9A illustrates an initial stage of a radially inward separation procedure for an end turn, and FIG. 9B illustrates a terminal stage of the radially inward separation procedure, in accordance with an embodiment of the present invention;

FIG. 10 illustrates a stator and a plurality of end turns in the stator subsequent to radially inward and outward end turn separation procedures, in accordance with an embodiment an embodiment of the present invention;

FIG. 11 illustrate an unfolded phase paper diaper, in accordance with an embodiment of the present invention;

FIG. 12 illustrates a stator having end turns that are electrically isolated from one another via a phase paper diaper, in accordance with an embodiment of the present invention; and

FIG. 13 illustrates in block form an exemplary process for separating adjacent end turns of a motor stator, in accordance with an embodiment of the present invention.

### DETAILED DESCRIPTION

As discussed in detail below, embodiments of the present invention provide apparatus and methods for stators and stator construction. Although the following discussion focuses on induction motors, the present invention also affords benefits to a number of applications involving other types of electric motors, such as direct current (dc) motors. Accordingly, the following discussion provides exemplary embodiments of the present invention and, as such, should not be viewed as limiting the appended claims to the embodiments described.

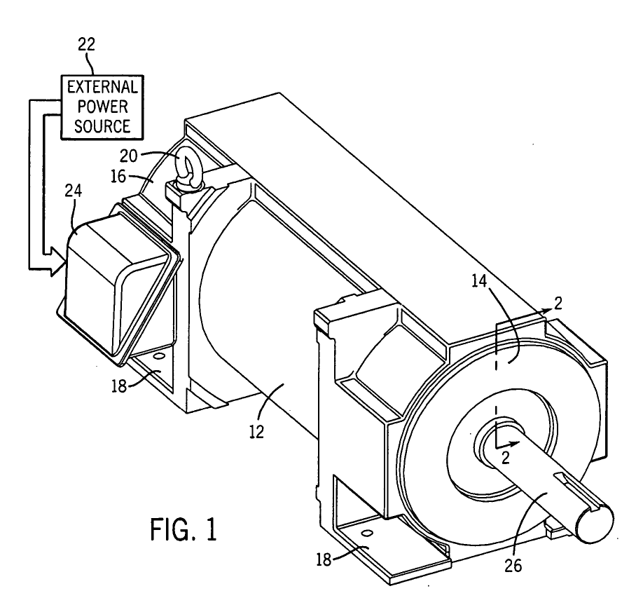

Turning to the drawings, FIG. 1 illustrates an exemplary electric motor 10. In the embodiment illustrated, the motor 10 comprises an induction motor housed in a National Electrical Manufacturers' Association (NEMA) motor housing. As appreciated by those of ordinary skill in the art, associations such as NEMA develop particular standards and parameters for the construction of motor housings or enclosures. The exemplary motor 10 comprises a frame 12 capped at each end by front and rear endcaps 14 and 16, respectively. The frame 12 and the front and rear endcaps 14 and 16 cooperate to form the enclosure or motor housing for the motor 10. The frame 12 and the front and rear endcaps 14 and 16 may be formed of any number of materials, such as steel, aluminum, or any other suitable structural material. The endcaps 14 and 16 may include mounting and transportation features, such as the illustrated mounting flanges 18 and eyehooks 20. Those skilled in the art will appreciate in light of the following description that a wide variety of motor configurations and devices may employ the techniques outlined below.

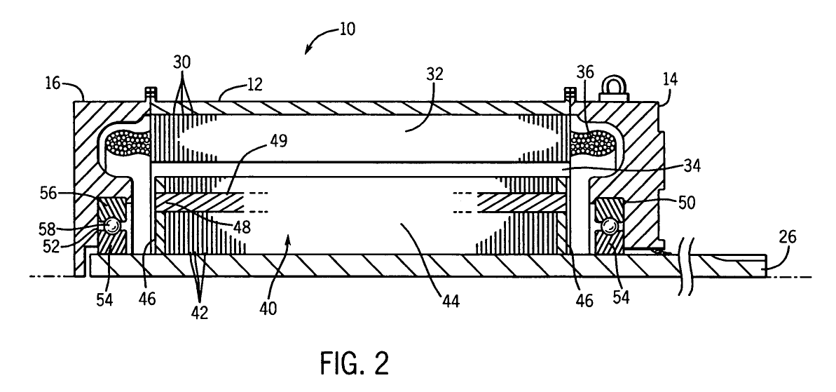

To induce rotation of the rotor, current is routed through stator windings disposed in the stator. (See FIG. 2.) Stator windings are electrically interconnected to form groups which are, in turn, interconnected in a manner generally known in the pertinent art. The stator windings are further coupled to terminal leads (not shown), which electrically connect the stator windings to an external power source 22, such as 480 Vac three-phase power or 110 Vac single-phase power. As another example, the external power source 22 may comprise an ac pulse width modulated (PWM) inverter. A conduit box 24 houses the electrical connection between the terminal leads and the external power source 22. The conduit box 24 comprises a metal or plastic material and, advantageously, provides access to certain electrical components of the motor 10. Routing electrical current from the external power source 22 through the stator windings produces a magnetic field that induces rotation of the rotor. A rotor shaft 26 coupled to the rotor rotates in conjunction with the rotor. That is, rotation of the rotor translates into a corresponding rotation of the rotor shaft 26. As appreciated by those of ordinary skill in the art, the rotor shaft 26 may couple to any number of drive machine elements, thereby transmitting torque to the given drive machine element. By way of example, machines such as pumps, compressors, fans, conveyors, and so forth, may harness the rotational motion of the rotor shaft 26 for operation.

FIG. 2 is a partial cross-sectional view of the motor 10 of FIG. 1 along line 2-2. To simplify the discussion, only the top portion of the motor 10 is shown, as the structure of the motor 10 is essentially mirrored along its centerline. As discussed above, the frame 12 and the front and rear endcaps 14 and 16 cooperate to form an enclosure or motor housing for the motor 10. Within the enclosure or motor housing resides a plurality of stator laminations 30 juxtaposed and aligned with respect to one another to form a lamination stack, such as a contiguous stator core 32. In the exemplary motor 10, the stator laminations 30 are substantially identical to one another, and each includes features that cooperate with adjacent laminations to form cumulative features for the contiguous stator core 32. For example, each stator lamination 30 includes a central aperture that cooperates with the central aperture of adjacent laminations to form a rotor chamber 34 that extends the length of the stator core 32 and that is sized to receive a rotor. Additionally, each stator lamination 30 includes a plurality of stator slots disposed circumferentially about the central aperture. These stator slots cooperate to receive one or more stator windings 36, which are illustrated as end turns in FIG. 2, that extend the length of the stator core 32.

In the exemplary motor 10, a rotor assembly 40 resides within the rotor chamber 34. Similar to the stator core 32, the rotor assembly 40 comprises a plurality of rotor laminations 42 aligned and adjacently placed with respect to one another. Thus, the rotor laminations 42 cooperate to form a contiguous rotor core 44. The exemplary rotor assembly 40 also includes rotor end members 46, disposed on each end of the rotor core 44, that cooperate to secure the rotor laminations 42 with respect to one another. When assembled, the rotor laminations 42 cooperate to form shaft chamber that extends through the center of the rotor core 44 and that is configured to receive the rotor shaft 26 therethrough. The rotor shaft 26 is secured with respect to the rotor core 44 such that the rotor core 44 and the rotor shaft 26 rotate as a single entity, the rotor assembly 40.

The exemplary rotor assembly 40 also includes electrically conductive nonmagnetic members, such as rotor conductor bars 48, disposed in the rotor core 44. Specifically, the conductor bars 48 are disposed in rotor channels 49 that are formed by amalgamating features of each rotor lamination 42, as discussed further below. Inducing current in the rotor assembly 40, specifically in the conductor bars 48, causes the rotor assembly 40 to rotate. By harnessing the rotation of the rotor assembly 40 via the rotor shaft 26, a machine coupled to the rotor shaft 26, such as a pump or conveyor, may operate.

To support the rotor assembly 40, the exemplary motor 10 includes front and rear bearing sets 50 and 52, respectively, that are secured to the rotor shaft 26 and that facilitate rotation of the rotor assembly 40 within the stationary stator core 32. During operation of the motor 10, the bearing sets 50 and 52 transfer the radial and thrust loads produced by the rotor assembly 40 to the motor housing. Each bearing set 50 and 52 includes an inner race 54 disposed circumferentially about the rotor shaft 26. The tight fit between the inner race 54 and the rotor shaft 26 causes the inner race 54 to rotate in conjunction with the rotor shaft 26. Each bearing set 50 and 52 also includes an outer race 56 and ball bearings 58, which are disposed between the inner and outer races 54 and 56. The ball bearings 58 facilitate rotation of the inner races 54 while the outer races 56 remain stationary and mounted with respect to the endcaps 14 and 16. Thus, the bearing sets 50 and 52 facilitate rotation of the rotor assembly 40 while supporting the rotor assembly 40 within the motor housing, i.e., the frame 12 and the endcaps 14 and 16. To reduce the coefficient of friction between the races 54 and 56 and the ball bearings 58, the ball bearings 58 are coated with a lubricant.

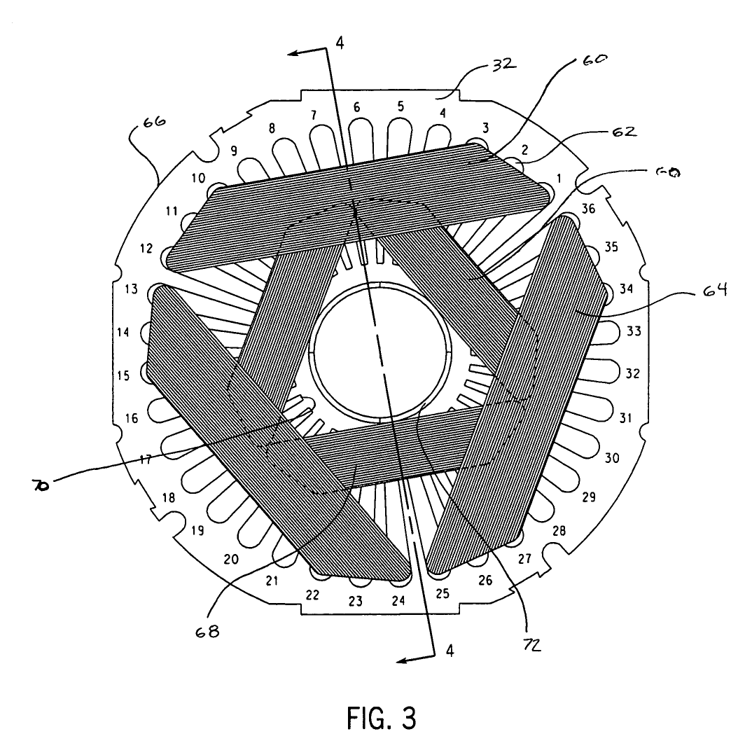

FIG. 3 illustrates, in schematic form, six groups of end turns 60 in an exemplary thirty-six-slot stator 32. As discussed above, each group of end turns is coupled to an electrical power source. Accordingly the coil winding in each group of end turns function as a single conductor. Thus, for the purposes of the present discussion, each group of end turns is referred to collectively as an end turn. In FIG. 3, the stator slots 62 of the stator 32 are numerically labeled. In the exemplary stator 32, the end turns 60 are illustrated prior to an end turn expansion procedure, which is discussed further below. That is to say, the end turns 60 are illustrated just subsequent to insertion of the coil windings 36 into the respective stator slots 62. By way of example, the coil windings 36 may be simultaneously inserted into the stator 32. In the exemplary stator 32, the coils windings 36 are arranged in a consequent pole winding pattern. As appreciated by those of ordinary skill in the art, the exemplary motor, because of the consequent pole winding pattern, is well suited to operate as a three-phase four-pole motor. However, the present technique is equally applicable to any number of coil winding patterns and arrangements, such as concentric winding patterns, lapped winding patterns, and so on. Moreover, the present technique is equally applicable to motors having varied electrical arrangements, e.g., three-phase two-pole motors, dc motors, to name but a few. Indeed, a wide variety of motor constructions may be envisaged and may benefit from the present technique.

In the exemplary stator 32, the end turns 60 present a two-tiered arrangement. Specifically, the stator 32 maintains three outer end turns 64 that are disposed towards the outer perimeter 66 of the stator 32 and three inner end turns 68 that are located towards the inner perimeter 70 of the stator 32. As illustrated in dashed line, portions of the inner end turns 68 rest directly behind portions of the outer end turns 64. As such, the portions of these end turns (i.e., the inner end turns 68 and outer end turns 64) can contact one another, which, in turn, can lead to short-circuiting of the electric motor for instance. As discussed further below, an electrically insulative material is placed between adjacent end turns to electrically isolate adjacent inner and outer end turns from one another.

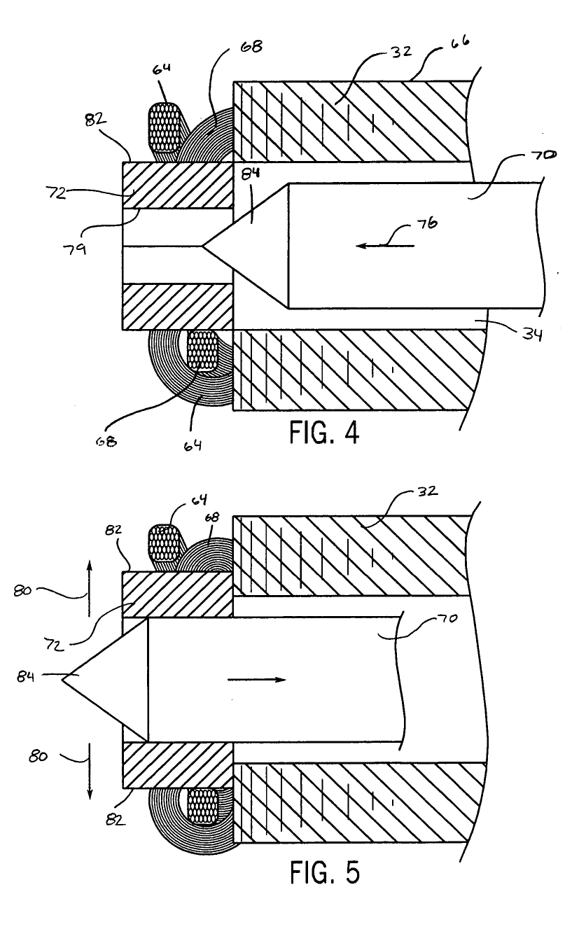

To facilitate a tight packing of the end turns with respect to one another and to drive the end turns 60 radially away from the rotor chamber 34, the inner and outer end turns undergo an end turn expansion procedure, as diagrammatically illustrated in FIGS. 4 and 5. In the exemplary stator 32, the end turns 64 and 68 are expanded by extending a plunger 70 through an expansion tool 72, which, in turn, drives the inner end turns 68 toward the outer end turns 64. More specifically, the plunger extends 70 axially through the rotor chamber 34, as represented by directional arrow 76. As the plunger 70 progresses axially through the rotor chamber 34 to the expansion tool 72, the inner walls 79 of the expansion tool 72 expand radially outward, as illustrated by directional arrows 80. In turn, the outer walls 82 of the expansion tool 72 drive the inner end turns 68, which are disposed radially closer to the rotor chamber 34 than the outer end turns 64, toward the outer end turns 64. Advantageously, the plunger 70 comprises a tapered nose 84 that facilitates engagement of the plunger 70 with the expansion tool 72. As another example, the expansion tool may be integrated into the plunger 70. Once the end turns 60 have been radially expanded, the plunger 70 is retracted and the expansion tool 72 removed.

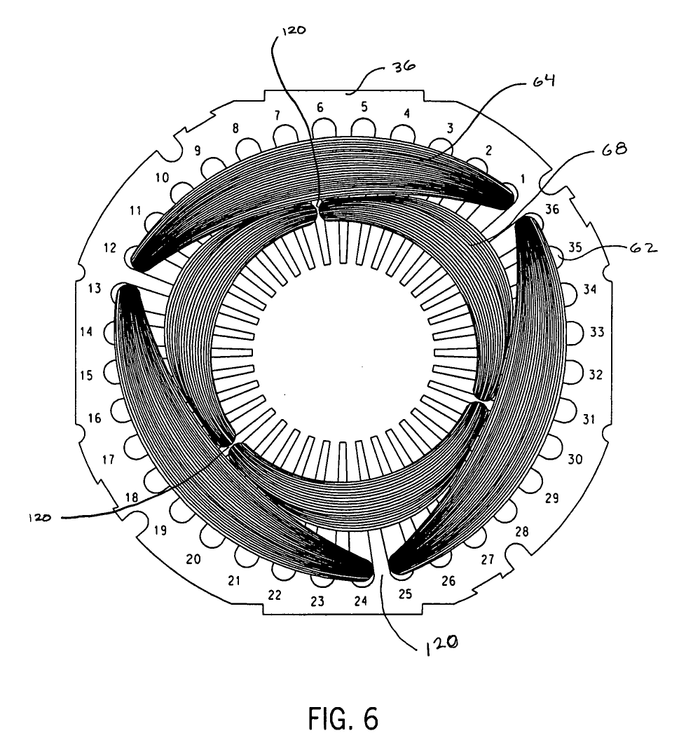

FIG. 6 illustrates the inner and outer end turns of the exemplary stator 32 after the expansion procedure. As discussed above, the expansion procedure drives the inner end turns 68 closer to the outer end turns 64. By way of example, the adjacent inner and outer end turns may contact one another, thereby causing the motor to short circuit, for instance. Accordingly, an electrically insulative material disposed between adjacent inner and outer end turn electrically isolates these end turns from one another, as discussed further below. However, the close proximity of these adjacent inner and outer end turns impedes the insertion of the insulative material therebetween, for instance.

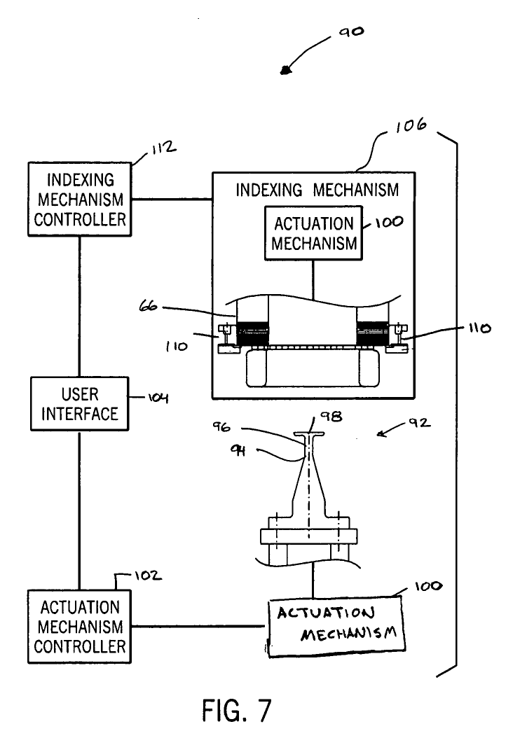

FIG. 7 schematically illustrates an exemplary system 90 for separating inner and outer end turns of a motor stator 32 with respect to one another. The system 90 includes a separation mechanism 92 that is configured to engage the end turns and to drive the engaged end turns in a desired radial direction with respect to the stator 32, as discussed further below. The separation mechanism 92 includes an engagement member, such as the illustrated grasping member 94, that is configured to engage with the appropriate inner or outer end turn to drive such end turn in the desired radial direction. For example, the exemplary grasping member 94 includes a stem 96 and a flanged portion 98 that extends radially outward from the stem 96. The stem 96 and flanged portion 98 cooperate to form hooked portion that are configured to capture the appropriate end turn during the separation procedure, as discussed further below. That is, when the grasping member 94 is radially actuated with respect to the stator 32, as discussed further below, the hooked portion engages with and captures an end turn and drives the end turn in the desired radial direction. However, the illustrated grasping member 94 is but one example of an engagement member, and other geometries and constructions may be envisaged.

To effectuate the desired movement of the grasping member 94, the exemplary separation mechanism 92 includes an actuation mechanism 100. The actuation mechanism 100 can comprise any number of structures that transition the grasping member 94 between desired positions, which are discussed further below. By way of example, the actuation mechanism 100 may include hydraulic components, geared members servo motors, belt drives or a combination thereof, to name just a few examples. Advantageously, the actuation mechanism 100 provides mechanical leverage to the grasping member 94, thereby facilitating radial displacement of the appropriate end turns, as discussed further below.

To control the actuation mechanism 100, the separation mechanism 92 comprises an actuation controller 102. By way of example, the actuation controller 102 may comprise any number of programmable logic devices, such as a programmable logic controller (PLC) or a processor based device, to name but a few. Advantageously, the actuation controller 102 can be programmed to direct the positioning of the grasping member 94 by the actuation mechanism 100 in a number of defined movement patterns, examples of which are discussed further below. In the exemplary separation mechanism, 92, a user interface 104, such as a keyboard or touch screen, facilitates programming and control of the actuation mechanism 100 by receiving inputs from a technician or user.

The exemplary system 90 also includes an indexing mechanism 106. In summary, the exemplary indexing mechanism 106 appropriately positions the stator 32 with respect to the separation mechanism 92. That is, the indexing mechanism 106 may be configured to support and orient the stator 32 during the separation procedure. By way of example, the indexing mechanism 106 includes a plurality of rollers 110 that support the stator 32 and that engage with the outer surface 66 of the stator 32 to orient the stator at various positions. Additionally, the indexing mechanism 106 may include an actuation mechanism 100, similar to the actuation mechanism 100 of the separation mechanism 92, that positions the supported stator 32 at desired locations. As discussed further below, appropriate movement of the stator 32 with respect to the grasping mechanisms 94 facilitates separation of adjacent inner and outer end turn with respect to one another. An indexing controller 112 directs the exemplary indexing mechanism 106. Similar to the actuation controller 102, the indexing controller 112 may comprise any number of programmable logic devices, such as a programmable logic controller (PLC) or a processor based device, to name but a few. Advantageously, the indexing controller 112 can be programmed to direct the indexing mechanism 106 to position the stator 32 in accordance with any number of defined movement patterns, examples of which are discussed further below. Advantageously, a technician may program the indexing mechanism 106 and/or the indexing controller 112 via the user interface 104. It is worth that the exemplary system 90 can effectuate movement of the stator 32 with respect to the grasping member 94, movement of the grasping member 94 with respect to the stator 32, or any combination thereof.

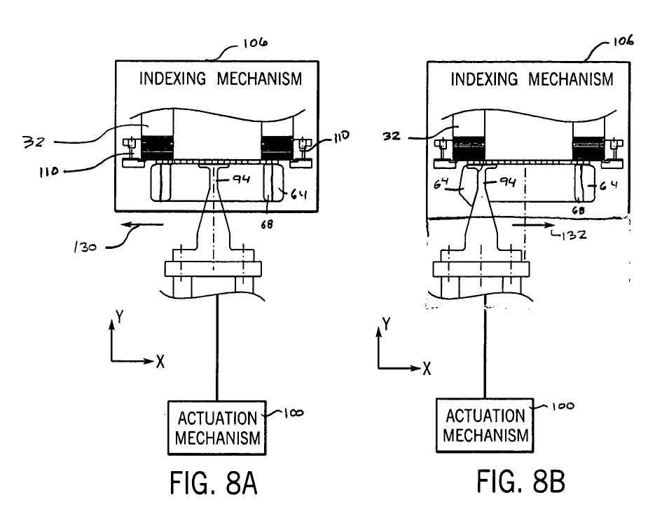

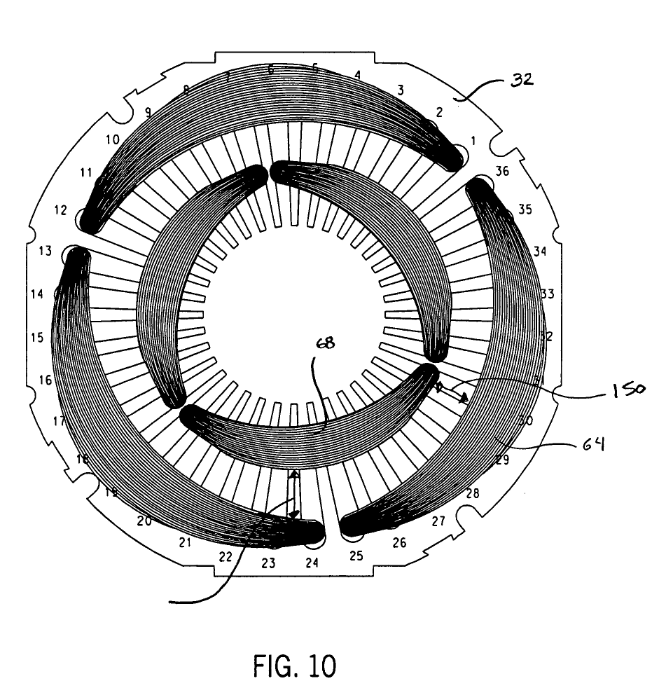

FIGS. 8A and 8B illustrate an exemplary movement pattern of the stator 32 and grasping member 94 for driving the outer end turns 64 radially outward with respect to the stator 32. In the following discussion, movements of the stator 32 and grasping member 94 are described in relation to the illustrated rectangular coordinate system. In the exemplary movement pattern, the grasping member 94 is axially and concentrically aligned with the stator 32. This alignment may be effectuated by movement of the stator 32, the grasping member 94, or a combination thereof. In the exemplary pattern, the actuation mechanism 100 moves the grasping member 94 radially outward with respect to the stator 32 and towards the end turns. With respect to FIG. 8A, the grasping member 94 moves along the negative x-axis. Advantageously, the stator 32 is oriented (via rotation of the stator 32 by the indexing mechanism 106) such that a gap 120 (see FIG. 6) between adjacent inner end turns 68 aligns with the X-axis, i.e., with the direction of movement of the grasping member 94. Accordingly, the gap 120 facilitates passage of the grasping member 94 radially outward toward the outer end turns 64 without interfering with the inner end turns 68. As the grasping member 94 travels radially outward (i.e., along the negative X-axis; arrow 130), the grasping member 94 comes into contact with the midpoint of an outer end turn 64. As the grasping member continues to travel in this direction, the hooked portion of the grasping member 94 engages with and captures the outer end turn 64. Further movement of the grasping member mechanically drives the captured outer end turn 64 radially outward with respect to the stator 32. By driving the outer end turns 64 radially outward, the radial separation (see FIG. 10) between adjacent inner and outer end turns is increased. As discussed further below, this increased separation distance facilitates the insertion of a dielectric material between the adjacent inner and outer end turns. Advantageously, the actuation mechanism 110 provides mechanical leverage to the grasping member 94, thereby facilitating movement of the captured end turn. Subsequently, the grasping member 94 returns to the neutral position by traveling along the positive X-axis (arrow 132) to complete the cycle.

The indexing mechanism 106 may orient the stator 32 to align the grasping mechanism 94 with another outer end turn 64 of the stator 32. For example, the exemplary indexing mechanism 106 may rotate the stator 32 one hundred and twenty degrees to align the grasping member with the midpoint of the next outer end turn 64 and as such the next gap 120 between adjacent inner end turns 68. However, the indexing mechanism 106 may position the stator 32 and grasping member 94 with respect to one another to align the grasping member at any number of desired or predefined locations on the outer end turn 64. Once properly oriented with the proper outer end turn 64, the grasping member 94 may then move radially outward (arrow 130) to drive the next outer end turn 64 in the same direction. The movement pattern then repeats for the remaining outer end turns 64. Advantageously, the mechanical actuation of the outer end turns 64 separates adjacent inner and outer end turns and facilitates the insertion of a dielectric material therebetween. Moreover, the separation mechanism 92 provides good leverage, thereby facilitating the conservation of material for the end turns 60. Furthermore, the mechanical leverage provided mitigates the likelihood of stray coil windings escaping the bundled end turn during the separation process.

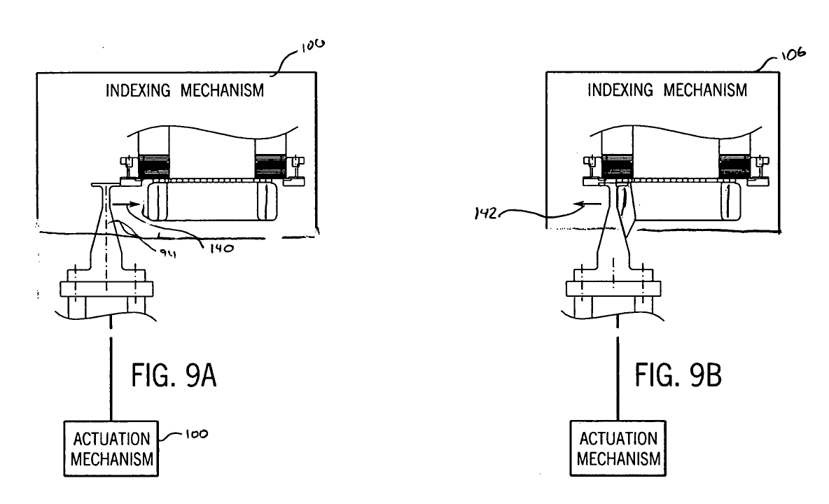

FIGS. 9A and 9B illustrate a movement pattern for mechanically driving the inner end turns 68 radially inward with respect to the stator 32. In the exemplary movement pattern, the grasping member 94 is positioned outside of the foot print of the stator 32, as best illustrated in FIG. 9A. As one example, the indexing mechanism 106 may orient the stator 32 such that the grasping member 94 aligns with a gap 120 between adjacent outer end turns 64. Once aligned, the grasping member is actuated radially inward (arrow 140) thereby grasping an inner end turn 68 and mechanically driving the inner end turn 68 radially inward. Subsequently, the grasping member 94 returns to the neutral position, as represented by directional arrow 142. The movement pattern then repeats for the remaining inner end turns 68. Indeed, in the exemplary embodiment, the indexing mechanism 106 may rotate the stator 32 such that the grasping member 94 aligns with the next gap 120 between adjacent outer end turns 64. Again, the mechanical actuation of the inner end turns 64 separates adjacent inner and outer end turns and facilitates the insertion of a dielectric material therebetween. Moreover, the separation mechanism 92 provides good leverage, thereby facilitating the conservation of material for the end turns 60. It should be noted, however, that foregoing is but one exemplary movement pattern, and that the exemplary separation mechanism 92 can effectuate separation of adjacent inner and outer end turns by actuating and orienting the stator 32 and the grasping member 94 with respect to one another in accordance with any number of movement patterns.

FIG. 10 illustrates a stator 32 in which the inner and outer end turns are separated with respect to one another. Via the procedures discussed above, the radial separation distance 150 between adjacent inner and outer end turns is increased. Advantageously, this increased radial separation distance facilitates the insertion of a dielectric material between these adjacent inner and outer end turns.

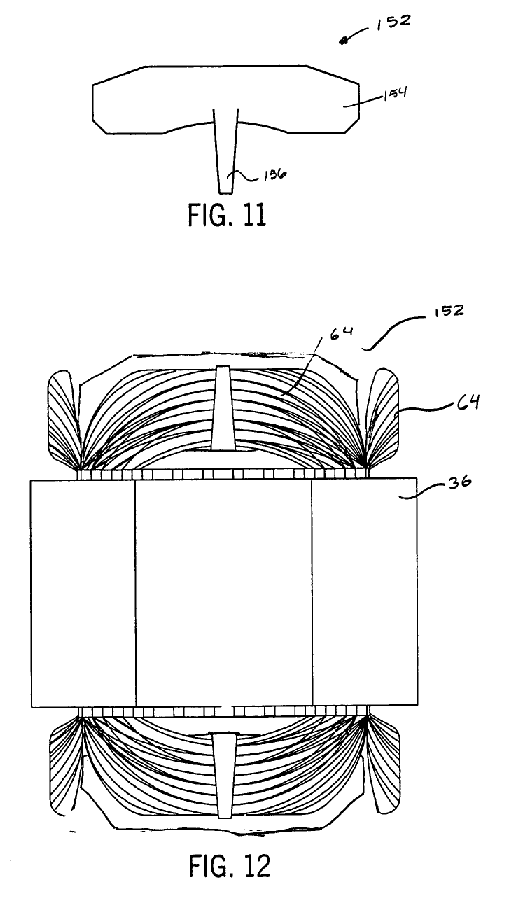

FIG. 11 illustrates an exemplary dielectric sheet or phase paper diaper 152 for insertion between adjacent inner and outer end turns. By way of example, the diaper 152 may comprise any number of electrically insulative materials, such as plastic. The exemplary diaper 152 includes a base portion 154 and a lip portion 156. As illustrated in FIG. 12, the diaper 152 may be inserted between adjacent inner and outer end turns. For example, the base portion 154 of the diaper 152 may be aligned with an outer end turn 64 such that the base portion 154 substantially covers the radially inward portion of the outer end turn 64. To secure diaper 152 to the outer end turn 64, the lip portion 156 is wrapped around the circumference of the outer end turn 64. By way of example, the lip portion 154 may be secured in position by electrical tape or any other suitable mechanism.

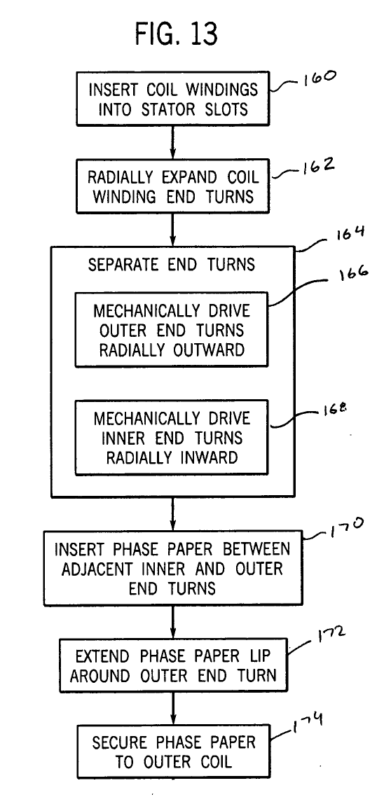

Keeping FIGS. 1-12 in mind, FIG. 13 illustrates in block form an exemplary process for manufacturing an electric motor. The process includes the act of inserting the coil winding 36 into the stator slots 62. (Block 160). As discussed above, the coil winding may be simultaneously inserted into their respective slots 62. Once inserted, the end turns 60 of the coil windings 36 remain exposed outside of the stator slots 62. The end turns 60 may be radially expanded to provide for a tight final packing, for instance. (Block 162.) The exemplary process also includes the act of radially separating adjacent inner and outer end turns with respect to one another. (Block 164.) This separation may be effectuated by mechanically driving the outer end turns 64 radially outward with respect to the stator 32 and/or mechanically driving the inner end turns 68 radially inward with respect to the stator 32. (Blocks 166 and 168.) The exemplary process also includes that act of inserting a phase paper diaper 152 between adjacent inner and outer end turns. (Block 170.) The phase paper 152 may be secured to the outer end turn 64 by extending the lip 156 circumferentially around the outer end turn 64 and securing the lip to the outer end turn with tape, for example. (Blocks 172 and 174.)

While only certain features of the invention have been illustrated and described herein, many modifications and changes will occur to those skilled in the art. It is, therefore, to be understood that the appended claims are intended to cover all such modifications and changes as fall within the true spirit of the invention.

1. An apparatus for separating adjacent end turns of a motor stator, comprising:
a separation mechanism configured to mechanically drive at least one of a first end turn in a radially outward direction with respect to the motor stator and a second end turn adjacent to the first end turn in a radially inward direction with respect to the motor stator such that a radial separation distance between the first and second end turns is increased.

2. The apparatus as recited in claim 1, wherein the separation mechanism comprises a hydraulic device configured to actuate an engagement member configured to receive an end turn.

3. The apparatus as recited in claim 2, wherein the engagement member comprises a hooked portion configured to capture an end turn.

4. The apparatus as recited in claim 1, comprising a geared actuation device configured to actuate an engagement member configured to receive an end turn.

5. An apparatus for separating adjacent end turns of a motor stator, comprising:
an engagement member; and
an actuation mechanism configured to actuate the engagement member in a first direction such that engagement member drives a first end turn radially outward with respect to the motor stator and in a second direction such that the engagement member drives a second end turn adjacent to the first end turn radially inward with respect to the motor stator.

6. The apparatus as recited in claim 5, wherein the engagement member comprises a hooked portion.

7. The apparatus as recited in claim 5, wherein the engagement member is coupled to the actuation mechanism via a conical shaped intermediate structure.

8. The apparatus as recited in claim 5, wherein the engagement member comprises a flanged portion.

9. The apparatus as recited in claim 5, wherein the actuation mechanism comprises a hydraulic device.

10. The apparatus as recited in claim 5, wherein the engagement member is configure to pass between circumferentially adjacent end turns of the motor stator.

11. A system for separating end turns of coil windings in a motor stator, comprising:
a separation mechanism comprising an engagement member and an actuation mechanism configured to actuate the engagement member between first and second positions such that the engagement member drives the end turn in a desired radial direction with respect to the motor stator; and
an indexing mechanism configured to position at least one of the motor stator and the engagement member with respect to one another such that engagement portion aligns with a predefined location on the end turn.

12. The system as recited in claim 11, wherein the indexing mechanism is configured to rotate the motor stator to align the engagement member with the end turn.

13. The system as recited in claim 11, wherein the separation mechanism is configured to drive a first end turn of the motor stator in a first direction and an second end turn adjacent to the first end turn in a second direction, wherein the first and second directions are generally opposite one another.

14. The system as recited in claim 11, comprising an expansion mechanism configured to drive a plurality of the end turns radially outward with respect to the motor stator.

15. The system as recited in claim 11, wherein the expansion mechanism expands radially outward in response to a plunger extending axially through a central aperture of the expansion mechanism.

16. The system as recited in claim 11, comprising the motor stator positionably secured to the indexing mechanism.

17. The system as recited in claim 11, wherein the indexing mechanism comprises a plurality of rollers configured to rotate the motor stator.

18. A method of manufacturing a motor stator, comprising:
mechanically driving at least one of a first end turn of the motor stator radially inward with respect to the motor stator and a second end turns adjacent to the first end turn of the motor stator radially outward with respect to the motor stator; and
inserting a dielectric material between the first and second end turns such that the first and second turns are electrically isolated from one another.

19. The method as recited in claim 18, comprising hydraulically driving at least one of the first and second end turns.

20. The method as recited in claim 18, comprising securing the dielectric material to at least one of the first and second end turns.

21. A method of manufacturing a motor stator having first and second end turn adjacent to one another, comprising:
aligning an engagement member with a predefined location on a first end turn;
mechanically biasing the engagement member into the first end turn such that the engagement member drives the first end turn in a radial direction with respect to the motor stator, thereby increasing the a radial separation distance between the first and second end turns; and
inserting an electrically insulative material between the first and second end turns such that first and second end turns are electrically isolated from one another.

22. The method as recited in claim 21, comprising hydraulic biasing the engagement member.

23. The method as recited in claim 21, comprising positioning a grasping member with respect to a first predefined location on the first end turn and positioning the grasping member with respect to a second predefined location on the second end turn.

24. The method as recited in claim 23, comprising rotating the motor stator to align the grasping member with respect to at least one of the first and second predefined locations.

25. The method as recited in claim 23, comprising actuating the grasping member such that the grasping member aligns with at least one of the first and second predefined locations.

26. A method of manufacturing a motor stator, comprising:
aligning a grasping member configured to capture an end turn of a motor with respect to a first predefined location of a first end turn;
mechanically actuating the grasping member such that the actuation drives the first end turn radially outward with respect to the motor stator;
aligning the grasping member with respect to a second predefined location of a second end turn adjacent to the first end turn;
mechanically actuating the grasping member such that the actuation drives the second end turn radially inward with respect to the motor stator; and
inserting a dielectric material between the first and second end turns such that the first and second end turn are electrically isolated from one another.

27. The method as recited in claim 26, comprising rotating the motor stator to align the grasping member with at least one of the first and second predefined locations.

28. The method as recited in claim 26, comprising securing the dielectric material to at least one of the first and second end turns.

29. An apparatus for separating adjacent end turns of a motor stator, comprising:
means for engaging an end turn of a motor stator; and
means for mechanically driving at least one of a first end turn of the motor stator radially inward with respect to the motor stator and a second end turn adjacent to the first end turn radially outward with respect to the motor stator.

30. An apparatus for separating adjacent end turns of a motor stator, comprising:
means for aligning a grasping member with respect to a first predefined location of a first end turn and a second predefined location of a second end turn;
means for mechanically actuating the grasping member such that the actuation drives the first end turn radially outward with respect to the motor stator; and
means for mechanically actuating the grasping member such that the actuation drives the second end turn radially inward with respect to the motor stator.
